(19) United States
(12) Patent Application Publication
(10) Pub. No.: US 2019/0358567 A1
(43) Pub. Date: Nov. 28, 2019

(54) SMART WIRELESS FUEL SYSTEM MONITOR INTEGRATED INTO A FUEL FILTER ASSEMBLY T-HANDLE

(71) Applicant: Parker-Hannifin Corporation, Cleveland, OH (US)

(72) Inventors: Martin Craig Maxwell, Moreland Hills, OH (US); Steven Robert Knight, Toano, VA (US)

(21) Appl. No.: 16/469,731

(22) PCT Filed: Mar. 2, 2018
(86) PCT No.: PCT/US2018/020635

§ 371 Date: Jun. 14, 2019

Related U.S. Application Data
(60) Provisional application No. 62/472,140, filed on Mar. 16, 2017.

(51) Int. Cl. B01D 35/143; B01D 37/04

(52) U.S. Cl. CPC B01D 35/1435; B01D 37/046; B01D 2201/24; B01D 2201/54; B01D 2201/301; B01D 2201/56

(57) ABSTRACT

A device and method for determining a filter element is approaching an end of life obtains vacuum data corresponding to a vacuum at a filter element, and concludes the filter element is approaching an end of life based on the vacuum data as it relates to time in service. The end of life of the filter element may be based on detection of a knee in a vacuum curve derived from the vacuum data, high and low vacuum measurements over a specific time period deviating from one another by more than a prescribed amount, or high and low vacuum curves derived from the vacuum data trending apart from one another by more than a prescribed amount.

This application claims the provisional benefit of U.S. Provisional Patent Application No. 62/472,140 filed Mar. 16, 2017, which is hereby incorporated herein by reference.

### FIELD OF INVENTION

The present disclosure relates to filter systems and, more particularly, to a smart filter monitor that can determine and/or predict when a filter element requires maintenance/replacement.

### BACKGROUND

It is well known to utilize fuel filter assemblies to filter fuel for a combustible engine of a motor vehicle. Such fuel filter assemblies typically comprise a sideways or downwardly mounted canister having a paper filter media enclosed in the canister. The fuel enters and fills the canister so that all of the filter media is doused with fuel as the fuel passes through the paper filter media and exits the canister to travel to the engine. Various contaminants are filtered from the fuel that would degrade the performance of the engine if left within the fuel.

All boats, particularly diesel powered, are susceptible to engine failure due to a plugged fuel filter. This usually happens at the worst time in heavy weather when the tank gets stirred up. Often boats have no indication for filter condition apart from a scheduled change out, which doesn't account for the widely varying reasons for early plugging. As a filter plugs, the vacuum required to draw fuel through it rises up to the point the fuel pump cannot draw enough fuel to run the engine.

A solution to this problem utilized a mechanical vacuum gauge that fastened to a modified T-Handle (which holds the lid on the filter assembly). The vacuum gauge accesses the vacuum side of the fuel system via an internal stand pipe to which the vacuum gauge is fastened. Unfortunately, filters do not plug in a linear fashion; the pressure drop rises with an exponential characteristic and therefore it can be difficult to assess filter condition using this method, as it requires looking at the vacuum gauge every so often. Further, a majority of the change in pressure drop occurs in the last 10% of the filter life. Other drawbacks include:
The gauge is hidden away—out of sight, out of mind;
Readings need to be taken at cruise rpm as the fuel flows faster, which requires leaving the helm to get to the engine compartment with a flashlight;
Mechanical methods for recording max vacuum are unreliable in practice; and
The added height makes them unusable in many tight installations as they impede the way you naturally turn a tight T-handle and can be broken.

### SUMMARY OF INVENTION

A device and method in accordance with the present invention monitor vacuum change on a vacuum side of a filter element over time to generate a vacuum data. The vacuum data is analyzed to determine if the filter element requires service. In determining if the filter element requires service, the vacuum data may be analyzed to detect a knee of the curve, detect divergence between high and low vacuum readings over time, or detect a high vacuum differing from a low vacuum by more than a prescribed amount. The knee of the curve, divergence between high and low vacuum readings over time, and the high vacuum differing from the low vacuum by more than a prescribed amount each occur near the end of life of the filter element. Upon detecting any one or more of the above-referenced events, an alert can be generated to indicate the filter element is near the end of its life giving sufficient time to procure and install a replacement.

Detection of the knee of the curve, divergence between high and low vacuum readings over time, or detection of a high vacuum differing from a low vacuum by more than a prescribed amount can eliminate the need for absolute measurements and can be self-calibrating, i.e., no user setup is required. Further, the vacuum sensor that collects the vacuum data can be configured to periodically communicate with a remote application, such as a phone app via Bluetooth. Communicating data to a phone app has numerous advantages, including:
No wiring compared to traditional sensors;
Vacuum over time data allows the phone to compute a predictive algorithm accurately tracking end of life;
Text and email warnings can be sent when filter is within a predefined range of change out;
With boat data, the app could even predict ‘hours before change out’ ahead of a longer trip;
App could ship new filters ahead of time, just before they are needed; and
With a motion sensor, app could relate sea state to filter plugging rate to indicate a fouled tank.

According to one aspect of the disclosure, a filter monitoring apparatus for detecting an end of life of a filter element includes: a processor and memory; and logic stored in the memory and executable by the processor, the logic comprising logic configured to obtain vacuum data corresponding to a vacuum through a filter element, and logic configured to conclude the filter element is approaching an end of life based on the vacuum data.

Optionally, the logic configured to obtain the vacuum data includes logic configured to record a high vacuum over each of a plurality of different time periods and a low vacuum over each of the plurality of different time periods, and the logic configured to conclude the filter element is approaching an end of life includes logic configured to conclude the filter element is at an end of life when a difference between the high vacuum over a particular time period and the low vacuum over the particular time period exceeds a prescribed threshold value.

Optionally, the logic configured to obtain the vacuum data includes logic configured to plot the high vacuum and low vacuum data over time, and the logic configured to conclude the filter element is approaching an end of life includes logic configured to conclude the filter element is at an end of life when the high vacuum plot and the low vacuum plot trend apart from one another by more than a prescribed value.

Optionally, the logic configured to obtain the vacuum data includes logic configured to plot the vacuum data over time to form a vacuum curve, and the logic configured to conclude the filter element is approaching an end of life includes logic configured to conclude the filter element is at an end of life when a knee is identified in the vacuum curve.

Optionally, the filter monitoring apparatus includes: a filter canister operably engaged with a filter head; and the filter element configured to be disposed in the filter canister, the filter element configured to separate a contaminant from a mixture.

Optionally, the filter monitoring apparatus includes a vacuum sensor in fluid communication with the filter canister, wherein the processor is communicatively coupled to the vacuum sensor to obtain vacuum data corresponding to a vacuum in the filter canister.

Optionally, the filter monitoring apparatus includes a handle having a proximal end, a distal end, and a port extending between the proximal and distal ends, wherein the distal end is configured to couple to the filter canister, and the proximal end comprises a vacuum sensor operatively coupled to the port.

Optionally, the filter monitoring apparatus includes a wireless transceiver operatively coupled to the processor, and logic configured to communicate at least one of vacuum data or vacuum events to a remote device via the wireless transceiver.

According to another aspect of the invention, a method of determining a filter element is approaching an end of life includes: obtaining vacuum data corresponding to a vacuum at a filter element; and concluding the filter element is approaching an end of life based on the vacuum data.

Optionally, obtaining the vacuum data includes recording a high vacuum over each of a plurality of different time periods and a low vacuum over each of the plurality of different time periods, and concluding the filter element is approaching an end of life includes concluding the filter element is at an end of life when a difference between the high vacuum over a particular time period and the low vacuum over the particular time periods exceeds a prescribed threshold value.

Optionally, obtaining the vacuum data includes plotting the high vacuum and low vacuum data over time, and concluding the filter element is approaching an end of life includes concluding the filter element is at an end of life when the high vacuum plot and the low vacuum plot trend apart from one another by more than a prescribed value.

Optionally, obtaining the vacuum data includes plotting the vacuum data over time to form a vacuum curve, and concluding the filter element is approaching an end of life includes concluding the filter element is at an end of life when a knee is identified in the vacuum curve.

Optionally, the method includes transmitting a warning to a remote device upon detecting the end of life of the filter element.

Optionally, the method includes receiving the warning on the remote device, and generating an alert to a user.

Optionally, transmitting the warning comprises transmitting the warning via at least one of a text message or an email.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Many aspects of the invention in accordance with the present disclosure can be better understood with reference to the following drawings. The components in the drawings are not necessarily to scale, emphasis instead being placed upon clearly illustrating the principles in accordance with the present disclosure. Likewise, elements and features depicted in one drawing may be combined with elements and features depicted in additional drawings. Additionally, in the drawings, like reference numerals designate corresponding parts throughout the several views.

FIG. 1 illustrates an exemplary vacuum curve on a vacuum side of a filter element.

FIG. 2 is a block diagram illustrating components of a marine vehicle, the marine vehicle including a filter monitor in accordance with the present invention.

FIG. 3 is a perspective view of an exemplary filter device that includes a filter monitor in accordance with an embodiment of the invention.

FIG. 4 is a side view of an exemplary T-handle that includes a filter monitor in accordance with an embodiment of the invention, the T-handle configured for use with a filter device.

FIG. 5 is a block diagram illustrating components of an exemplary filter monitor in accordance with the invention.

FIG. 6 is a flow chart illustrating an exemplary method of determining the end of life of a filter element in accordance with an embodiment of the invention.

FIG. 7 is a flow chart illustrating an exemplary method of determining the end of life of a filter element in accordance with another embodiment of the invention.

FIG. 8 is a flow chart illustrating an exemplary method of determining the end of life of a filter element in accordance with another embodiment of the invention.

FIG. 9 is a schematic view of an electronic device executing an application in accordance with an embodiment of the invention.

### DETAILED DESCRIPTION

Embodiments in accordance with the present invention will be primarily described in the context of a fuel filter for a marine vessel. It will be appreciated, however, that embodiments in accordance with the present invention may be employed in other types of vehicles and/or in other types of applications. For example, embodiments in accordance with the invention may be applied to fuel filters, oil filters, air filters, etc. for use in recreational vehicles, commercial trucks, passenger cars, pumping applications and the like.

Filters are well-known devices that are used to separate a contaminant from a mixture. For example, a fuel filter may be used to separate contaminants, such as dirt, rust, etc. from fuel in order to provide the engine with clean fuel.

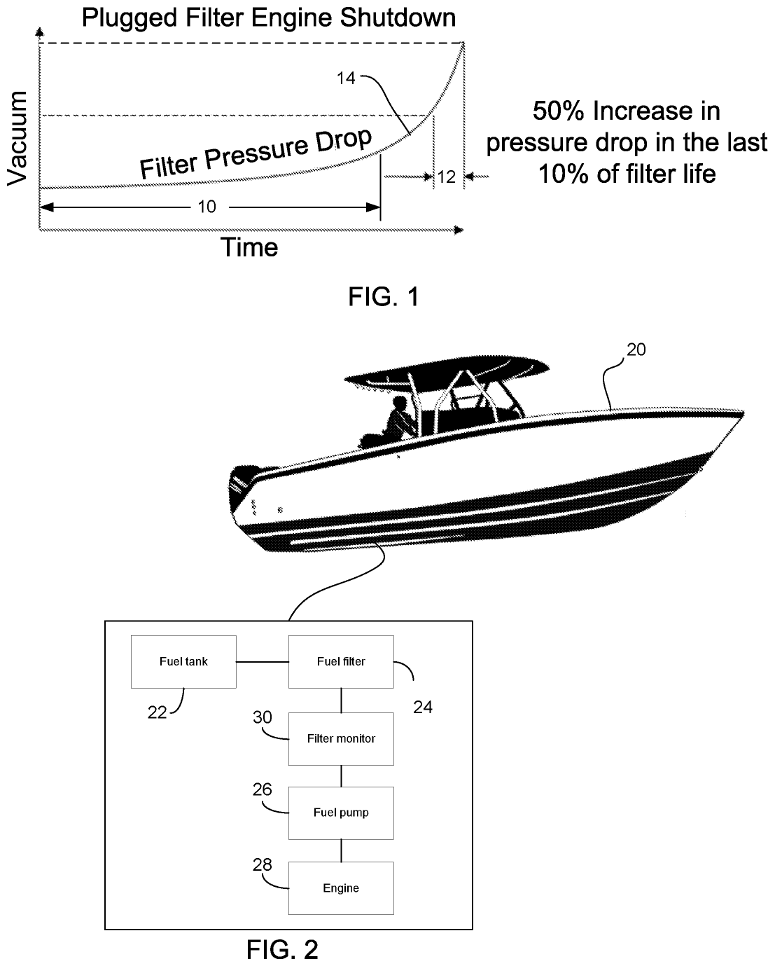

Filters do not plug in a linear fashion, but follow more of an exponential curve. For example, when a vacuum through the filter element has a 50% increase relative to when the filter was first placed in service, if one were to assume a linear filter plugging model then it may be concluded the filter has 50% life remaining. However, due to the exponential characteristics of filter plugging, the filter may only have 10% life remaining. This characteristic of filters can be seen in FIG. 1, where the change in vacuum over the majority 10 of the filter's life is gradual, appearing almost linear when the filter is relatively new. Near the end of the filter's life 12, however, the vacuum change sharply increases. This is due to the fact that near the end of the filter's life most of the filter's surface area is clogged, leaving only a small portion for passing fuel through the filter. The loss of surface area requires the fuel pump to work harder to get the required fuel through the filter, which results in increased vacuum.

A device and method in accordance with the present invention monitor the vacuum change at the filter over time and can detect when the filter is approaching the end of life. As used herein, the end of life of the filter element means that a surface area of a filter medium of the filter element is at least 80 percent clogged, and more preferably at least 90 percent clogged.

As the filter becomes plugged, the vacuum change gradually increases until a critical point when the filter is nearing the end of its life. At this point the vacuum change over time starts to noticeably acellerate, which is identified in FIG. 1 by a knee 14 of the curve. In one embodiment, the vacuum change over time is plotted to generate a curve, and the curve is analyzed to check for the presence of a knee in the curve. Such method can eliminate the need for absolute measurements and would self-calibrate/learn new types of systems without requiring user setup.

Fuel flow rate is proportional to RPM due to commonly used mechanical fuel pumps. For self-calibrating reasons, and the fact all fuel systems have different vacuum characteristics, the system can learn after a reset what a normal range looks like accounting for varying flow rates due to ROM. With this in mind, in another embodiment a high vacuum reading and a low vacuum reading for each of a plurality of time periods is obtained, and when the high vacuum trends away from the low vacuum by a predetermined amount it may be concluded that the filter is at the end of life. For example, over a first one-hour time period the high vacuum and low vacuum over that one-hour period is recorded. Then for the next one-hour time period, the high and low vacuum over that period is again recorded. Such recording may continue in order to develop a history of the high and low vacuum readings and thus form a curve. The difference between the high vacuum curve and the low vacuum curve can be compared, and when one curve trends away from the other curve by more than a prescribed value (i.e., the high vacuum reading is trending away from the low vacuum reading), it can be concluded that the filter is near the end of its life.

In yet another embodiment, the difference between a high vacuum reading and a low vacuum reading for a given point in time can be obtained. If the difference between the high vacuum reading and the low vacuum reading for the given point in time is greater than a prescribed value, it can be concluded that the filter element is near the end of its life.

Moving now to FIG. 2, illustrated is a block diagram of the components for an exemplary boat 20 that includes a filter monitor device in accordance with the present invention. The exemplary boat 20 includes a fuel tank 22 for storing fuel, such as diesel or gasoline. The fuel is drawn through a filter device 24 via fuel pump 26 and provided to engine 28 as is conventional. A filter monitor device 30 in accordance with the present invention is operatively coupled to the filter device 24 so as to monitor a vacuum change at the filter device 26.

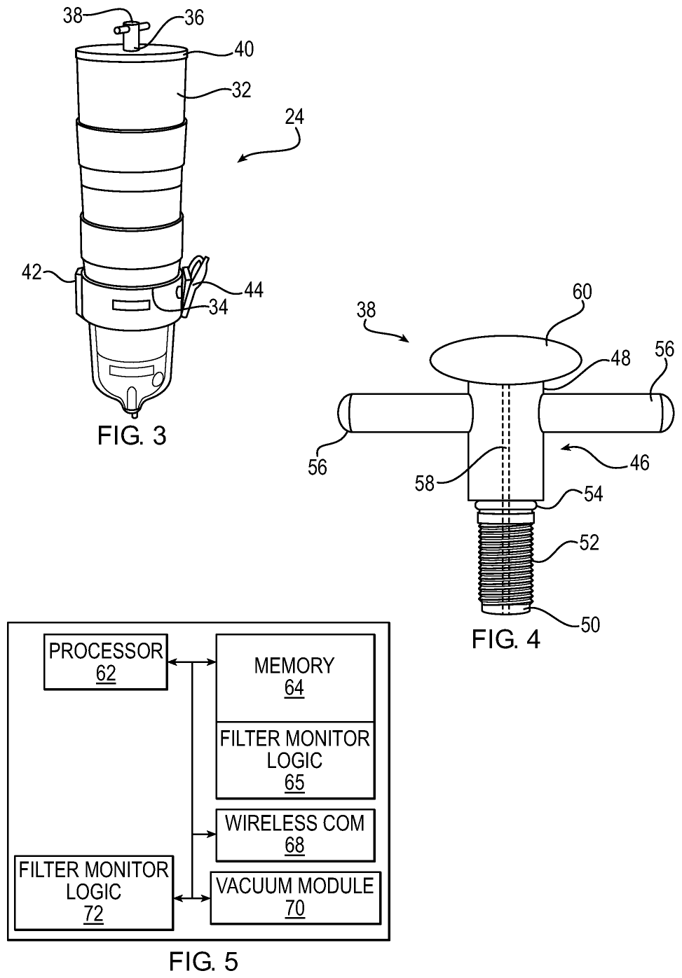

With additional reference to FIG. 3, illustrated is an exemplary filter device 24 that may be used with principles of the present invention. The filter device 24 comprises a filter canister 32 that houses a filter element (not shown in FIG. 2) to block a contaminant, for example, dirt, rust, etc. within a fuel or mixture. The filter element within the filter canister 32 may be threadedly, sealedly or non-sealedly engaged with a filter head 34, for example. The filter element may be accessed, for example, by removing a T-handle 38 (described in more detail below) and lifting a top cover 40 of the filter canister 32, thereby exposing the filter element.

A port 36 is in fluid communication with an inside of the filter canister 34, the port including a threaded end for receiving the T-handle 38. Unfiltered mixture enters the filter via inlet port 42, where it enters the filter canister 32 and passes through the filter element. The filtered fluid then exits the filter device via outlet port 44.

FIG. 4 illustrates an exemplary T-handle 38 in accordance with the present invention in more detail. The exemplary T-handle 38 includes an elongated body portion 46 having a proximal end 48 and a distal end 50. The distal end 50 is configured to couple to the filter canister, for example, via a threaded portion 52 that cooperatively engages with a corresponding threaded portion of the port 36 in the filter device 24. An O-ring 54 provides a seal between the T-handle and the filter device 24. At the proximal end 48, handle portions 56 extend radially outward from the body portion 46, the handle portions facilitating rotation of the body portion 46 as the T-handle 38 is inserted/removed from the filter device 24.

The T-handle 38 further includes a port 58 passing through the body portion 46 and extending between the proximal end 48 to the distal end 50. When the T-handle 38 is inserted in the filter device 24, the port 58 is in fluid communication with a vacuum side of the filter element. In the exemplary embodiment, filter monitor circuitry 60 is arranged on the proximal end 48 of the T-handle 46, the filter monitor circuitry 60 including a vacuum sensor operatively coupled to the port 58 so as to monitor the vacuum at the filter element.

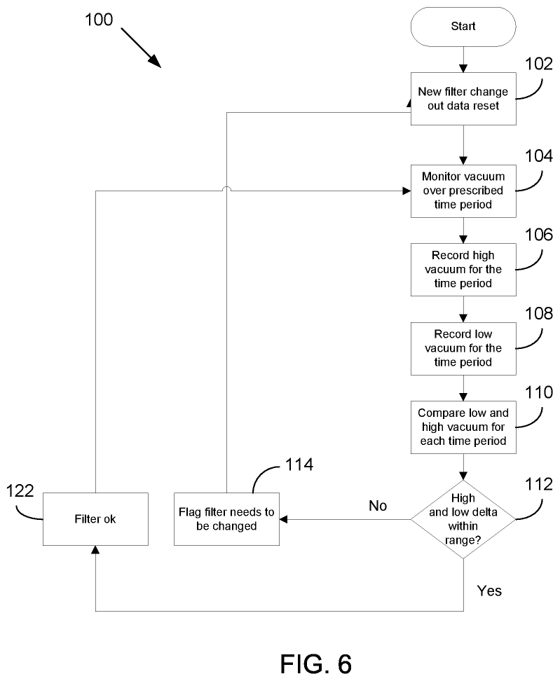

With additional reference to FIG. 5, illustrated is a block diagram of the filter monitor circuitry 60 in accordance with an embodiment of the invention. The filter monitor circuitry 60 includes a processor 62 and memory 64 communicatively coupled to each other via a bus 66. The memory 64 may include volatile memory and non-volatile memory as is conventional. Stored in the memory 64 or in a separate memory is filter monitor logic 65. The filter monitor logic 65 is executable by the processor 62 so as to cause the processor to carry out one or more of the methods described herein. Further details concerning the filter monitor logic are described below with respect to FIGS. 6-8. The filter monitor circuitry 60 further includes a wireless communication module 68 connected to the bus 66 that enables short-range wireless communication to communicate at least one of vacuum data or vacuum events to a remote device. The wireless communication module 68 may take the form of a WiFi, Bluetooth or other like technology that enables short range wireless communications. The filter monitor circuitry 60 also includes a vacuum module 70 connected to the bus 66, the vacuum module in fluid communication with the port 58 so as to obtain a vacuum measurement in the filter canister. The vacuum module 58 includes a vacuum sensor and associated circuitry to enable the processor 62 to obtain vacuum measurements at the vacuum side of the filter element. The processor 62 is communicatively coupled to the vacuum module 58 via the bus 66 to obtain vacuum data corresponding to a vacuum in the filter canister.

With additional reference to FIGS. 6-8, illustrated are logical operations to implement an exemplary method 100, 100a and 100b of monitoring the status of a filter element in accordance with the present invention. Although FIGS. 6-8 show a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Referring first to FIG. 6, the logical flow for the filter monitoring function begins at block 102 where all filter data is reset to signify that a new filter element has been installed in the filter. Such reset may be formed, for example, manually as the filter is changed (e.g., via a setup utility), or automatically via a sensor that detects when the filter element has been replaced.

Next at block 104 the processor 62, via the vacuum module 70, obtains vacuum data at a vacuum side of at the filter device 24. In one embodiment, a high vacuum is recorded over each of a plurality of different time periods and a low vacuum is recorded over each of the plurality of different time periods, as indicated at blocks 106 and 108. The time periods may be any length of time as required by the specific application. For monitoring a fuel filter of an engine, the time period may be one hour. Thus, over each one-hour period the highest and lowest vacuum readings over that one-hour period may be retained.

Next at block 110, the processor 62 compares the respective low and high vacuum recordings for each respective time period, and at block 112, it is determined if the respective high and low vacuum recordings for each time period are within a prescribed range of one another.

A new filter will have very little difference in vacuum no matter what the fuel flow. As the filter plugs, this becomes larger and larger. If the respective high and low vacuum measurements for one or more time periods is/are not within a prescribed range of one another, this indicates the filter element is nearing the end of its life and the method moves to block 114 where a flag is set to indicate that the filter is near the end of its life. As described in more detail below, the flag may be used to generate an alarm, send a text message alert, etc. in order to notify a user that the filter element is approaching the end of its life. The method then moves back to block 102 and repeats.

Moving back to block 112, if the respective high and low vacuum measurements are within the prescribed range of one another, then the method moves to block 122 where it is concluded that the filter element still has useful life remaining and the method moves back to block 104 and repeats.

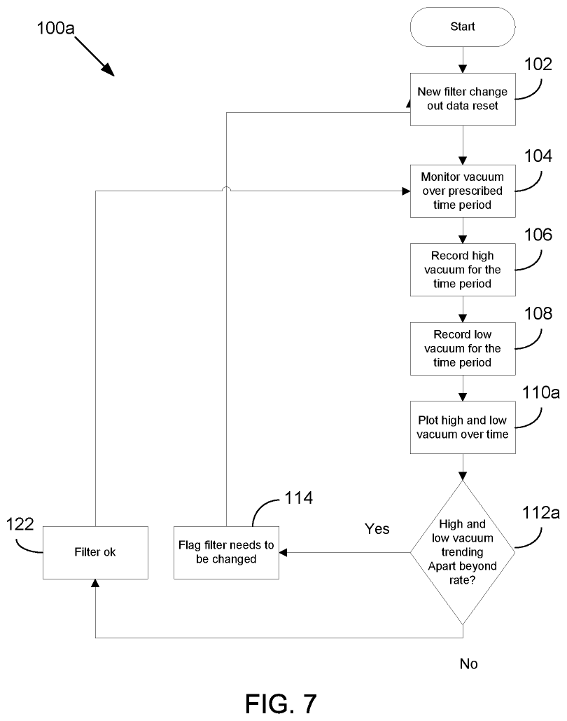

Moving to FIG. 7, illustrated is a method 100a in accordance with another embodiment of the invention. The method according to FIG. 7 is similar to the method of FIG. 6 and therefore only the differences between the respective methods are discussed below.

In the method of FIG. 7, instead of comparing the respective high and low vacuum recordings, the high and low vacuum recordings are plotted as indicated at block 110a. By plotting the high and low vacuum recordings over time, high and low curves are formed that define the vacuum at the filter device 24 over time.

Next and block 112a it is determined if the high and low vacuum curves as plotted at block 110a are trending apart beyond a prescribed rate. As used herein, “trending apart” is defined as a difference between a high vacuum recording and a low vacuum recording increasing over time.

While the filter element still has useful life remaining, the high and low vacuum curves will be approximately equidistant from one another. However, as the filter element approaches the end of its life the high vacuum curve and the low vacuum curve will begin to trend apart from one another. If the high and low vacuum curves trend apart by more than a prescribed value, then at block 112a the method moves to block 114 where a flag is set to indicate that the filter is near the end of its life. The method then moves back to block 102 and repeats.

Moving back to block 112a, if the high and low vacuum curves have not trended apart by more than a prescribed amount, then the method moves to block 122 where it is concluded that the filter element still has useful life remaining and the method moves back to block 104 and repeats.

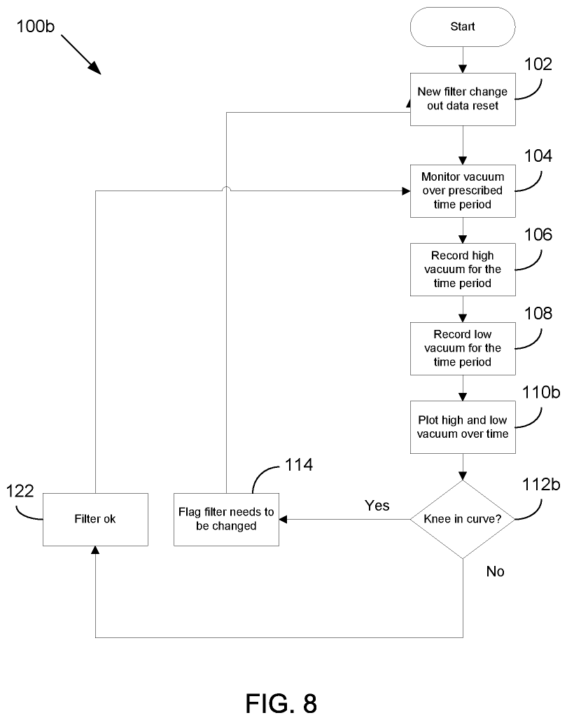

Moving to FIG. 8, illustrated is a method 100b in accordance with yet another embodiment of the invention. The method according to FIG. 8 is similar to the method of FIG. 6 and therefore only the differences between the respective methods are discussed below.

In the method of FIG. 8, instead of comparing the high and low vacuum recordings, at least one of the high and low vacuum recordings is plotted as indicated at block 110b. As discussed above with respect to FIG. 7, by plotting the vacuum recording(s) a curve is formed that defines the vacuum at the filter device over time.

Next and block 112b it is determined if a knee exists in the plotted vacuum curve. While the filter element still has useful life remaining, the vacuum curve will rise in an approximately linear fashion. However, as the filter element approaches the end of its life the vacuum curve will begin sharply increase (e.g., the vacuum curve may exponentially increase). This sharp increase is defined as the knee of the curve and provides an indication that the filter element is nearing the end of its life.

To determine the existence of a knee in the curve, the process may calculate the rate of change in vacuum over time. When the rate of change of vacuum over time exceeds a prescribed value, then the processor may conclude that a knee in the curve has been detected. If a knee in the vacuum curve is detected, then at block 112b the method moves to block 114 where a flag is set to indicate that the filter is near the end of its life. The method then moves back to block 102 and repeats.

Moving back to block 112b, if a knee in the curve is not detected, then the method moves to block 122 where it is concluded that the filter element still has useful life remaining and the method moves back to block 104 and repeats.

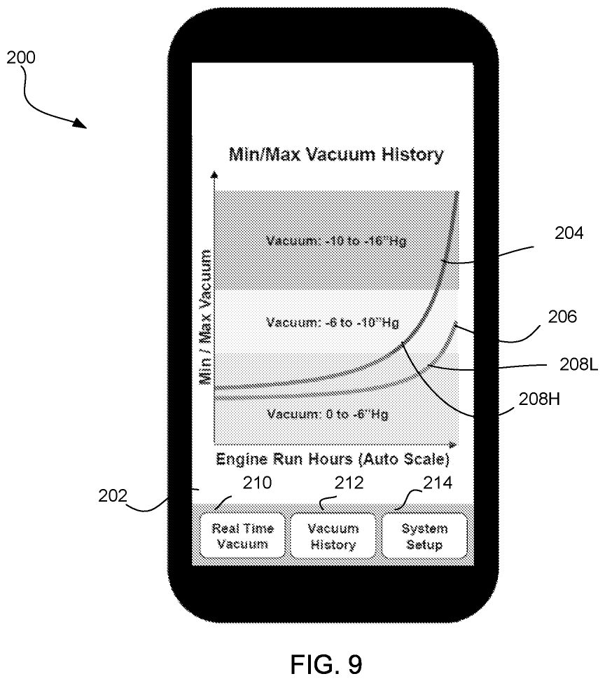

Moving now to FIG. 9, illustrated is an exemplary application (“app”) in accordance with the present invention executing on an electronic device 200, such as a mobile phone. The app obtains vacuum data pertaining to the filter device 24 via a wireless connection to the filter circuitry 60. For example, a Bluetooth or other like wireless technology may be employed to communicate vacuum data and other data related to the filter device 24 from the filter circuitry 60 to the electronic device 200.

The app executing on the electronic device 200 may present the data on a display 202 of the electronic device 200 in any one of a number of different formats. In the Example shown in FIG. 9, a high vacuum curve 204 and a low vacuum curve 206 are illustrated. As can be seen from FIG. 9, the high and low vacuum curves initially track each other, rising in an approximately linear fashion over time. However, near the end of the life of the filter element, the high vacuum curve 204 begins to rise faster than the low vacuum curve 206, thereby trending away from the low vacuum curve 206. Further, both curves exhibit a knee (208H for the high vacuum curve and 208L for the low vacuum curve). Both the knee in the curve and the trending away of the respective curves can be used to identify when the filter element is near the end of its life.

The app may include various soft keys that provide different functions. For example, a real time soft key 210 may display the current vacuum at the filter device 24 in real time, while a vacuum history soft key 212 can provide a history of the high and/or low vacuum over time (FIG. 9 illustrates high and low vacuum history curves). A system setup soft key 214 may enable the user to access setup parameters that define how data will be displayed, alarm setpoints, wireless communication parameters, email and/or text notifications, engine and/or vehicle information, filter information, etc.

The filter monitor device 30 in accordance with the invention can also be used to communicate data from other sensors to a remote device, such as a mobile phone, laptop computer, etc. For example, other sensors can be communicatively coupled to the filter monitor device, for example, by directly wiring the sensors to inputs of the filter monitor device 30. The wireless communication function of the filter monitor device 30 then can be used to communicate data from the other sensor(s) to the remote device. Such other sensors may include, for example, an accelerometer and/or an exhaust temperature gauge. The data from these sensors then can be used to monitor the status of various systems of the boat.

For example, marine wet exhausts normally run cool due to the continuous flow of relatively cool sea water over the exhaust. However, if the water impellor on the engine fails then the flow of water is reduced and, as a result, the exhaust temperature heats up much faster than the engine temperature. By periodically communicating the exhaust temperature to the remote device via the wireless communications capabilities of the filter monitor device 30, the discrepancy between the exhaust temperature and the engine temperature can be detected and an alert can be provided to the user that there is a problem with the water impellor.

Additionally, an accelerometer in combination with the vacuum data can be used to determine the condition of a fuel tank. Over time fuel tanks may accumulate significant sediment that typically remains along the bottom of the tank. In smooth seas the sediment does not get stirred up and does not cause any problems as it remains on the bottom of the tank. However, in heavy seas the sediment is mixed in with the fuel and, as a result, the fuel filter must filter an excessive amount of contaminants from the fuel, which can significantly shorten the life span of the fuel filter.

In order to detect sediment in the fuel tank, the accelerometer data and vacuum data can be analyzed together to determine if there is a correlation between high seas and shortened filter life. For example, if the rate of the vacuum increase at the filter element is significantly faster when in high seas than when in calm seas, this indicates that there is sediment in the tank. Based on such correlation between the type of seas and the rate at which the vacuum increases at the filter element, it can be determined whether or not there is sediment in the fuel tank.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A filter monitoring apparatus for detecting a filter element is at an end of life, comprising:
a processor and memory; and
logic stored in the memory and executable by the processor, the logic comprising
logic configured to obtain vacuum data corresponding to a vacuum at the filter element, and
logic configured to conclude the filter element is at an end of life based on the vacuum data.

2. The apparatus according to claim 1, wherein the logic configured to obtain the vacuum data comprises logic configured to record a high vacuum over each of a plurality of different time periods and a low vacuum over each of the plurality of different time periods, and wherein the logic configured to conclude the filter element is at an end of life comprises logic configured to conclude the filter element is at an end of life when a difference between the high vacuum over a particular time period and the low vacuum over the particular time period exceeds a prescribed threshold value.

3. The apparatus according to claim 1, wherein the logic configured to obtain the vacuum data comprises logic configured to plot the high vacuum and low vacuum data over time, and wherein the logic configured to conclude the filter element is at an end of life comprises logic configured to conclude the filter element is at an end of life when the high vacuum plot and the low vacuum plot trend apart from one another by more than a prescribed value.

4. The apparatus according to claim 1, wherein the logic configured to obtain the vacuum data comprises logic configured to plot the vacuum data over time to form a vacuum curve, and wherein the logic configured to conclude the filter element is at an end of life comprises logic configured to conclude the filter element is at an end of life when a knee is identified in the vacuum curve.

5. The apparatus according to claim 1, further comprising:
a filter canister operably engaged with a filter head; and
the filter element configured to be disposed in the filter canister, the filter element configured to separate a contaminant from a mixture.

6. The apparatus according to claim 5, further comprising a vacuum sensor in fluid communication with the filter canister, wherein the processor is communicatively coupled to the vacuum sensor to obtain vacuum data corresponding to a vacuum in the filter canister.

7. The apparatus according to claim 1, further comprising a handle having a proximal end, a distal end, and a port extending between the proximal and distal ends, wherein the distal end is configured to couple to the filter canister, and the proximal end comprises a vacuum sensor operatively coupled to the port.

8. The apparatus according to claim 7, wherein the handle comprises a T-handle.

9. The apparatus according to claim 1, further comprising a wireless transceiver operatively coupled to the processor, and logic configured to communicate at least one of vacuum data or vacuum events to a remote device via the wireless transceiver.

10. The apparatus according to claim 9, further comprising at least one other sensor communicatively coupled to the filter monitoring apparatus, wherein the wireless transceiver is configured to communicate data from the at least one other sensor to the remote device.

11. A system comprising the apparatus according to claim 9, and the remote device.

12. A method of determining a filter element is at an end of life, comprising:
obtaining vacuum data corresponding to a vacuum at a filter element; and
concluding the filter element is at an end of life based on the vacuum data.

13. The method according to claim 10, wherein obtaining the vacuum data comprises recording a high vacuum over each of a plurality of different time periods and a low vacuum over each of the plurality of different time periods, and wherein concluding the filter element is at an end of life comprises concluding the filter element is at an end of life when a difference between the high vacuum over a particular time period and the low vacuum over the particular time periods exceeds a prescribed threshold value.

14. The method according to claim 10, wherein obtaining the vacuum data comprises plotting the high vacuum and low vacuum data over time, and wherein concluding the filter element is at an end of life comprises concluding the filter element is at an end of life when the high vacuum plot and the low vacuum plot trend apart from one another by more than a prescribed value.

15. The method according to claim 10, wherein obtaining the vacuum data comprises plotting the vacuum data over time to form a vacuum curve, and wherein concluding the filter element is at an end of life comprises concluding the filter element is at an end of life when a knee is identified in the vacuum curve.

16. The method according to claim 10, further comprising transmitting a warning to a remote device upon detecting the filter element is at the end of life.

17. The method according to claim 14, further comprising receiving the warning on the remote device, and generating an alert to a user.

18. The method according to claim 15, wherein transmitting the warning comprises transmitting the warning via at least one of a text message or an email.

19. The method according to claim 11, further comprising:
obtaining motion data corresponding to a motion of a storage tank that supplies fluid to the filter element; and
determining from the vacuum data a first rate of change of vacuum over time for motion of the storage tank that is less than a prescribed level of motion;
determining from the vacuum data a second rate of change of vacuum over time for motion of the storage tank that is greater than the prescribed level of motion; and
concluding the storage tank includes sediment when the second rate of change of vacuum is greater than the first rate of change of vacuum by more than a prescribed value.
